(19) United States
(12) Patent Application Publication
(10) Pub. No.: US 2002/0040480 A1
(43) Pub. Date: Apr. 4, 2002

(54) On-demand camera relay method and device

(75) Inventor: Kunihiko Koike, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: KOIKE DESIGN COLLABORATION INC.

(21) Appl. No.: 09/930,256

(22) Filed: Aug. 16, 2001

(30) Foreign Application Priority Data
Sep. 29, 2000 (JP) 2000-298369

(51) Int. Cl. H04N 7/18

(52) U.S. Cl. 725/105; 348/143

(57) ABSTRACT

A method is provided to enable a viewer to remotely operate a camera via communication circuits, so that images desired by each viewer can always be obtained. This invention provides an on-demand camera relay method for one-to-one connection of a plurality of cameras and a plurality of receiving devices, and comprising a step in which a plurality of video cameras, each having remotely operable directional devices, and an audio input device are arranged in front of a stage or field; a step in which output from the plurality of cameras and from the audio input device is distributed to a plurality of viewers via a wide area electronic circuit network; and a step in which, using a receiving device possessed by each viewer which displays the distributed images and audio and input means, each viewer can operate the above directional devices.

### BACKGROUND OF THE INVENTION

1. Field of the Invention

This invention relates to an on-demand camera relay method enabling remote operations by individual viewers, using an on-demand camera relay device, which includes a plurality of remotely operable cameras.

2. Description of the Related Art

Conventional systems are known which enable a user to obtain a desired image by the transmission of images, captured by one or more of cameras, to a receiving device via communication circuits, and by manipulating the viewable range via communication circuits (Japanese Patent Provisional Publication No. 9-163356). In this system, the user can specify the range to see within the range of images stored in memory.

A system is also known in which, on the Internet World Wide Web, a user who has obtained camera control privileges remotely operates a camera by operating a personal computer terminal, enabling the acquisition of a desired image (Japanese Patent Provisional Publication No. 10-93855). In this system, numerous unspecified users operate one or a plurality of cameras via communication circuits. However, the number of users who have camera control privileges is limited. Not all users can always obtain desired images; moreover, the time during which control privileges can be held is limited.

A remote-operation camera relay system characterized in that a camera server is provided, and remote operation instructions from numerous unspecified users are accommodated, is also known (Japanese Patent Provisional Publication No. 11-55561). In this method the camera server processes collectively the remote operation instructions from a plurality of client computers to control cameras. It is not always possible for the users of individual client computers to perform desired remote operations.

### SUMMARY OF THE INVENTION

An object of this invention is to provide an on-demand camera relay method and device, which enable each viewer to remotely control one video camera or a similar device while providing remotely controlled images to a plurality of viewers.

In order to achieve this object, in this invention the method of the present invention enables a one-to-one connection in which one camera is connected to only one receiving device, so that the camera can be operated remotely via communication circuits by a viewer who has the receiving device.

That is, this invention provides an on-demand camera relay method, comprising the steps of positioning a plurality of video cameras, each having a remotely-operable directional device, and an audio input device, in front of a stage or field; distributing output from the plurality of cameras and from the audio input device to a plurality of viewers via broad band digital communication circuits; and by means of the receiving device and its input means displaying distributed images and audio possessed by each viewer, allowing each viewer to operate the above directional devices.

Further, this invention provides an on-demand camera relay device comprising a plurality of video cameras, which can be operated remotely via communication circuits using this relay method. Also, this invention provides an on-demand camera relay device comprising a plurality of units, each of which include a camera in which a lens part and solid-state image capture element are integrated; a directional device that is remotely operable and on which the camera is mounted so as to point the camera in an arbitrary direction; and a signal processing part including an output circuit connected to the camera for processing electrical signals from the camera. It is preferable that the above cameras and the above output circuits are provided separately, and are connected by cables. The above units of the above on-demand camera relay device preferably include a remotely operable audio input device as well; and it is preferable that the above units are connected in a one-to-one relationship to receiving devices, which output images to viewers.

Thus by means of the on-demand camera relay device of this invention and an on-demand camera relay method using this device, video and audio services which more closely meet the desire of each individual viewer can be provided. Because the method of this invention does not require any large-scale equipment, it is possible to easily provide services in accordance with the present invention.

In this invention, because one camera may be allocated beforehand to each one of all viewers, each viewer can obtain the desired relayed images using cameras dedicated to the viewer, without being affected by connections to cameras or by control privileges shared by other viewers.

### BRIEF DESCRIPTION OF THE DRAWINGS

FIG. 1 is a drawing showing the overall configuration of an on-demand camera relay method enabling remote operation, using an on-demand camera relay device;

FIG. 2 is a drawing showing the camera and signal processing part used in the on-demand camera relay device;

FIG. 3 is a side view of a pan/tilter, which is one aspect of the directional device used in the on-demand camera relay device;

FIG. 4 is a front view of a pan/tilter, which is one aspect of the directional device used in the on-demand camera relay device; and,

FIG. 5 is a drawing showing an operating device, displayed on the display of a personal computer, which is one aspect of a remote operation input device used in the on-demand camera relay device.

### DETAILED DESCRIPTION OF THE PREFERRED EMBODIMENT(S)

Aspects of this invention are explained in detail, referring to the drawings. However, the aspects explained below do not limit the scope of this invention.

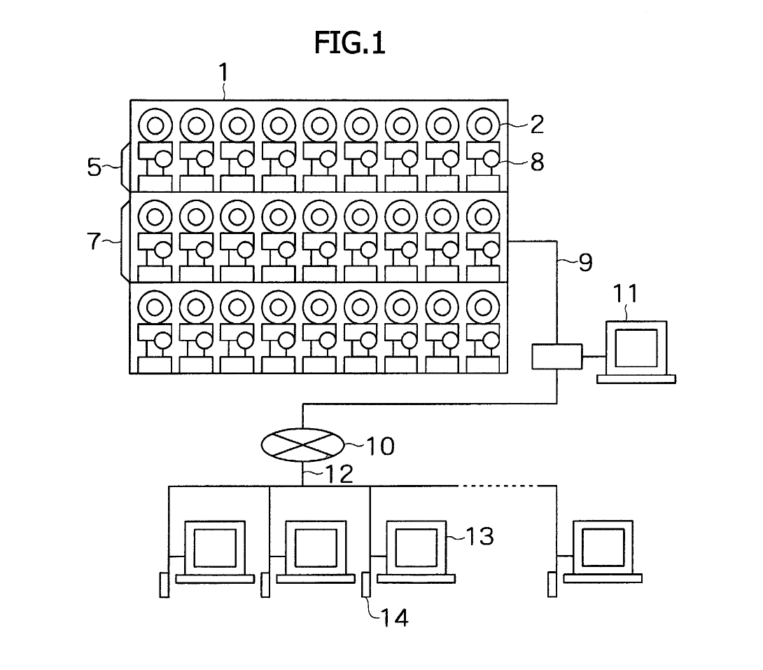

FIG. 1 is a drawing showing the overall configuration of an on-demand camera relay method, including the on-demand camera relay device of this invention. The on-demand camera relay device 1 of this invention comprises a plurality of camera units 7, each comprising a camera 2, directional device 5 which points the camera in an arbitrary direction, and signal processing part 6 which processes electrical signals sent from the camera. The digital output of this on-demand camera relay device 1 is connected, via a cable 9 of the necessary length, to a computer 11 connected to the Internet 10. Images input from a plurality of cameras 2 are digitally processed by the signal processing parts 6, and are transmitted, via the Internet 10 over communication circuits 12, to receiving devices 13 which correspond to the plurality of cameras 2 in a one-to-one relation. At this time, image data and audio data are compressed and sent. It is preferable that the communication rate is 128 kbits/second or higher, and if possible 512 kbits/second or higher; however, this invention is not limited to a specific communication rate. The receiving device 13 converts digitally processed signals, and displays images on a display screen. In response to displayed images, a viewer inputs the desired camera orientation and other information to a remote operation input device 14. The remote operation input device 14 transmits control signals input by the viewer to the computer 11 which is the reception processing part of the on-demand camera relay device 1 via communication circuits 12 and the Internet 10. According to these control signals, the directional device 5 is remotely operated, so that the orientation of the camera 2 can be changed. When the lens of the camera is a zoom lens, the lens field can be expanded or reduced, in order to obtain a desired image size and magnification.

In the actual implementation of this invention, when for instance relaying a live concert using the device of this invention, it is preferable that at least 50 camera units be provided, and if possible 100 or more; depending on circumstances, it may be preferable that 200 or more, 500 or more, or 1000 or more cameras be provided. The theoretical upper limit to the number of unit cameras is at present approximately 2000, but a greater number is also possible.

This invention is characterized in that signals input from a specific camera unit 7 are transmitted only to a specific receiving device 13, and signals transmitted from a specific remote operation input device 14 are transmitted only to a specific directional device 5, in a one-to-one connection. In this way, a set of a single camera unit 7, receiving device 13 and remote operation input device 14 is completely independent of other sets of a camera unit 7, receiving device 13 and remote operation input device 14, so that the operations of each viewer are not affected by the camera unit operations of other viewers. Individual viewers can always perform desired operations. Moreover, these sets are completely independent, so that there is no trouble for connections even when numerous camera units are provided.

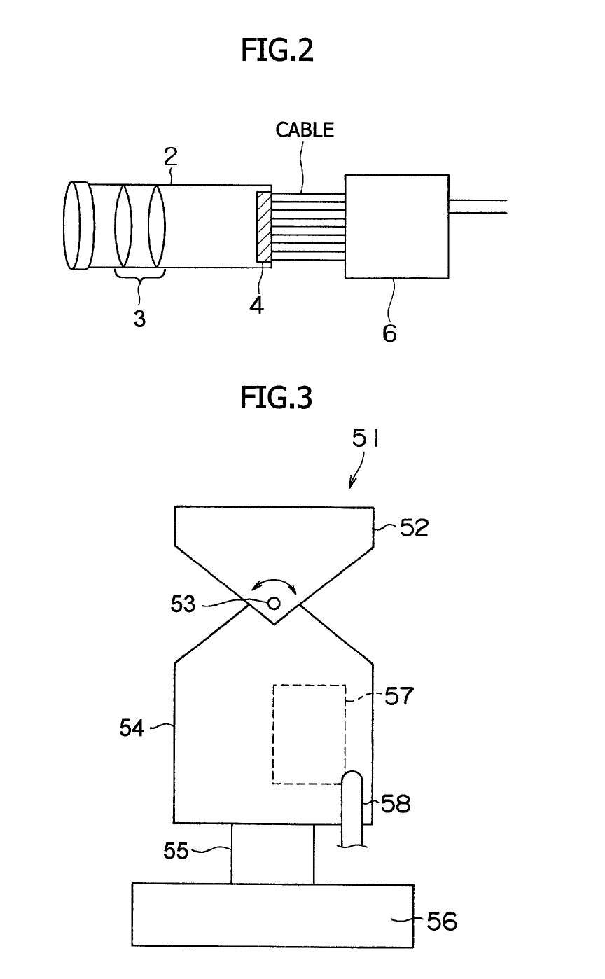

Below, component elements of the on-demand camera relay method and device of this invention are explained in detail, referring to the drawings. One aspect of the camera of this invention is shown in FIG. 2. The camera 2 comprises, integrally, a lens part 3, which focuses optical signals from the object into an image, and an image-capture element part 4, which converts the optical signals representing the image received by the lens part 3 into electrical signals.

A commercially marketed CCD camera can be used as a camera, which integrates the lens part and image-capture element part. These technologies are publicly known, and required devices can be manufactured according to the application and purpose.

As the lens part 3, a zoom lens, wide-angle lens, telescopic lens, bifocal lens, or other lens may be used, depending on the images to be captured. When particularly small-size cameras are required, a pinhole lens can also be used; but the lens is not limited to these examples. It is also possible to change the lens part according to the application and intentions.

In one aspect of this invention, a zoom lens is used. Here it is desirable that the zoom lens also be remotely operable. As with the directional device 5, remote controls can be performed by operating the remote operation input device 14, via the communication circuits 12.

The image-capture element part 4 converts optical signals from the object, focused by the lens part 3, into electrical signals. As image-capturing elements, such solid-state image-capturing elements as CCDs (charge-coupled devices), MOS (metal-oxide semiconductor) devices, and CMOS (complementary metal-oxide semiconductor) devices are known; these can be used as image-capturing elements, dependent on the application.

The camera is mounted on the remotely operable directional device 5 in order to point the camera in an arbitrary direction. As the directional device 5, a pan/tilter, which rotates in right and left directions and also in vertical directions, can be used.

By separating the camera and the output signal processing circuit, and connecting them with a cable, the camera alone is mounted on the directional device, so that the orientation of the camera can be altered more easily. By this means, mutual interference by the plurality of cameras comprised by the on-demand camera relay device with the operation of directional devices can be prevented, and cameras can be included in a smaller relay device.

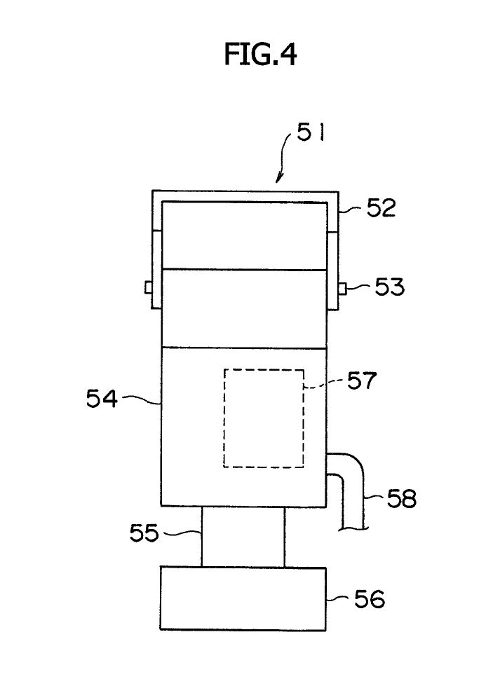

The pan/tilter 51, which is one example of the directional device 5 of this invention, is shown in a side view in FIG. 3, and in a front view in FIG. 4. The pan/tilter 51 is a directional device in which the camera is mounted on a pedestal 52, enabling rotation in horizontal and vertical directions. The pedestal 52 is installed by a shaft 53 onto the pan/tilter body 54, and is capable of tilting by ±90° about the shaft 53. The rotating part 55 mounted on the pan/tilter body 54 is installed by means of a panning motor, not shown, on the supporting base 56, to enable rotation in the horizontal direction, whereby the rotating part 55 is enabled to rotate through ±180° in the horizontal direction.

A cable for remote control 58 is connected to the pan/tilter 51 to enable remote control. The remote control signals transmitted from the viewer via the remote operation cable 58 control a pan/tilter control part 57 comprised by the pan/tilter 51, enabling changes in direction as described above. The technology for remote operation of the pan/tilter is publicly known (as in Japanese Patent Provisional Publication No. 9-298725 and elsewhere), and by utilizing this technology, a remotely operable pan/tilter can be fabricated. By mounting the camera 2 on such a pan/tilter 51, it is enabled to direct the camera.

However, the directional device can be fabricated according to the application, and is not limited to a pan/tilter. As a separate aspect of the directional device 5, a device, which enables parallel motion horizontally and vertically, is also conceivable.

In one aspect of this invention, an audio input device 8 is further installed on the camera unit 7. As the audio input device 8, a commercially marketed small-size microphone can be used. In another aspect, input is also possible from a single audio input device, mounted on the on-demand camera relay device 1 itself. In still another aspect, the viewer to create a desired acoustical effect by adjusting the output level can use audio input uniformly by a system completely separate from these units. In still another aspect, audio is input from numerous microphones or other devices. A viewer can select the number and positions of these microphones by means of the remote operation input device 14.

Electrical signals transmitted from the image-capture element part 4 are processed by the signal processing part 6, and processed digital signals are transmitted via the cable 9 to the computer 11 connected to the Internet 10. The Internet 10 transmits the digitized signals to individual viewers via communication circuits 12.

The computer 11 also plays the role of a signal processing part, which processes signals from remote operation input devices 14 and controls directional devices 5.

As the communication circuits 12, telephone circuits, satellite communication circuits, circuits for wire broadcasting, wireless communication circuits or similar can be used; but this invention is not limited to these.

The receiving device 13 should be able to receive and convert digital signals transmitted from the on-demand camera relay device 1 via communication circuits 12, into images. For example, a personal computer equipped with software capable of processing digital signals, a television capable of displaying digital information, or the liquid crystal display part of a portable telephone equipped with signal processing functions, can be used as the receiving device, but this invention is not limited to these. Receiving devices can also be manufactured, with a desired shape and size, in accordance with the system of this invention.

The remote operation input device 14 digitizes the directional device control conditions and other information input by a viewer, and transmits this to the computer 11, which is the reception processing part. Operations may, for example, be performed at a personal computer terminal, using software to transmit remote operation signals, with a pointing device. Alternatively, the function of transmitting remote operation signals can be added to the remote control of a television set to enable such operation. This invention is not limited to these examples. A joystick or similar controller suitable for the purpose of this invention can also be provided.

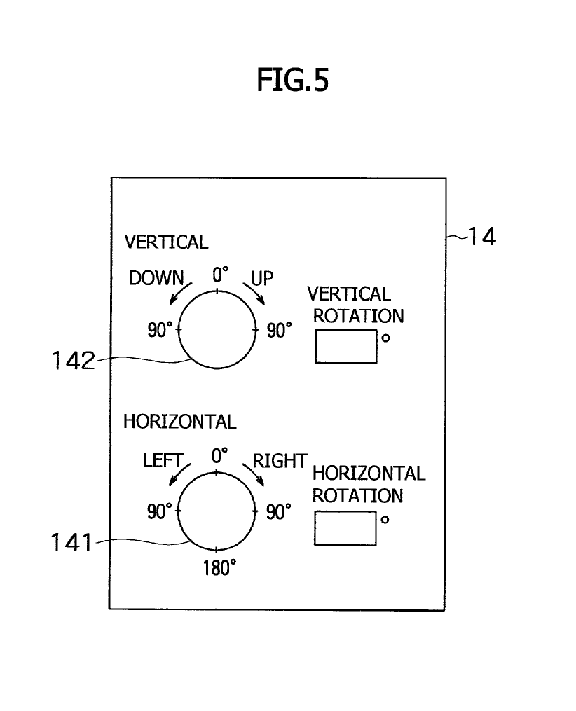

FIG. 5 shows the remote operation input device 14 of one aspect of this invention. The remote operation input device 14 shown in FIG. 5 is incorporated in a personal computer terminal; the operation screen shown in FIG. 5 can be displayed on the personal computer display when necessary and user can input instructions by pointing device or with keyboard operations. This operation screen comprises a pan operation part 141 and a tilt operation part 142 to operate the directional device 5; a desired rotation angle can by input through keyboard operations, and a pointing device can be used to specify the desired rotation angle on the screen. The viewer operates the pan operation part 141 and tilt operation part 142 while viewing images transmitted to the display, and can direct the camera mounted on the directional device in a desired direction to obtain a desired image.

By using these systems, the viewer can receive images input from a specific camera 2 via separate communication circuits 12, by operating the remote operation input device 14 can control the directional device 5, and by directing the camera 2 in the desired direction, can obtain desired images. That is, the viewer can be always connected to the camera unit 7, and can always receive desired images and perform desired remote operations.

In one aspect of this invention, the on-demand camera relay device 1 can be installed so as to be fixed in place in a theater, a baseball field, or similar. For example, in the case of installation in a baseball field, soccer field or similar, on-demand camera relay devices each comprising 1000 camera units can be installed on the first-base side and on the third-base side.

In another aspect of this invention, the on-demand camera relay device can be mounted on a movable device, such that the on-demand camera relay device is capable of motion. For example, units can be installed on a movable vehicle; wheels can be added to units, which can be pulled by another vehicle; or, installation on the bottom of a ship or on a helicopter or other flying craft is also possible. Installation on other movable devices is also possible, but this invention is not limited to these.

In still other aspects of this invention, the on-demand camera relay device 1 may be provided with a complete waterproofing device so that it can be used underwater; or may be provided with a heat-resistant device so that it can be used in high-temperature areas; or may have cold-resistant specifications so that it can be used in frigid areas. The on-demand camera relay a device can take various shapes according to its application. For example, if images and audio are acquired primarily from the front direction, in a theater, a box-shaped on-demand camera relay device, with cameras positioned vertically and horizontally, can be installed in the direction in front of the stage. If images looking downward from above are desired, an on-demand camera relay device can be fabricated to have a planar shape, such that it can be installed on the ceiling.

Next, an embodiment is discussed for describing this invention more specifically. This embodiment does not limit the scope of this invention.

Embodiment 1

The on-demand camera relay device of this invention can be used for broadcasting a concert. For example, when using an on-demand camera relay device, which has 1000 CCD cameras; the on-demand camera relay device is installed at an appropriate position enabling a sufficiently panoramic view of the stage and/or the inside of the concert hall. Each viewer, to whom one camera out of the 1000 cameras has been allocated in advance, can utilize communication circuits to receive images and audio input from the above camera on a television set, personal computer, or other receiving device. Further, while viewing the received image, the viewer can use a specific remote operation input device such as a joystick, or can perform operations on a personal computer, to freely perform remote operation of the allocated camera and audio input system via communication circuits, in order to obtain desired images and audio. Further, one person can use two or three circuits to freely operate a plurality of different cameras, enabling display of a plurality of pictures on one or a plurality of receiving devices.

What is claimed is:

1. An on-demand camera relay method, comprising the steps of:
providing a plurality of video cameras, each having remotely operable directional devices, and an audio input device in front of a stage or field;
transmitting an output from the plurality of cameras and from the audio input device to a plurality of viewers via a broad band electronic communication circuit network; and,
allowing each viewer to operate said directional devices using a receiving device each viewer has which displays the transmitted images and sound.

2. An on-demand camera relay device, comprising a plurality of video cameras which can be remotely operated via communication circuits.

3. The on-demand camera relay device according to claim 2, comprising a plurality of units, each of which comprises a camera which has a lens part and an image-capture element; a remotely operable directional device, on which the camera is mounted so as to make it possible to point the camera in an arbitrary direction; and a signal processing part connected to the camera and having an output circuit to process electrical signals from the camera.

4. The on-demand camera relay device according to claim 3, wherein said camera and said output circuit are provided separately and are connected by a cable.

5. The on-demand camera-relay device according to any of claim 3 or 4, wherein said units further comprise remotely operable audio input devices.

6. The on-demand camera relay device according to any of claim 3 to 5, wherein said units are connected to receiving devices which output images for viewers in a one-to-one relationship.
